(19) United States
(12) Patent Application Publication
(10) Pub. No.: US 2018/0260744 A1
(43) Pub. Date: Sep. 13, 2018

(54) ONLINE FORECASTING SYSTEM AND ONLINE FORECASTING METHOD

(71) Applicant: HITACHI, LTD., Tokyo (JP)

(72) Inventors: Koji FUKUDA, Tokyo (JP); Tadayuki MATSUMURA, Tokyo (JP)

(73) Assignee: HITACHI, LTD., Tokyo (JP)

(21) Appl. No.: 15/756,456

(22) PCT Filed: Sep. 2, 2015
(86) PCT No.: PCT/JP2015/074899

§ 371 Date: Feb. 28, 2018

(51) Int. Cl. G06Q 10/04; G06Q 10/06

(52) U.S. Cl. CPC G06Q 10/04; G06Q 10/06315

(57) ABSTRACT

There is provided a system that forecasts an index value of a predetermined day based on input data of the predetermined day in which result data of an index value of a day before the predetermined day is stored, similarity between the input data of the predetermined day and each of the stored result data is calculated, a weight is calculated for each result data based on the calculated similarity, and a forecasted index value of the predetermined day is prepared based on the calculated weight, the result data, and the input data of the predetermined day.

### TECHNICAL FIELD

The present invention relates to an online forecasting system and an online forecasting method.

### BACKGROUND ART

An online forecasting system in which a series of flows that new data is input every day, a value of a certain index is forecasted based on the new data and past result data previously stored, a certain optimization or decision making is performed based on the forecasted value, and while processing or observation is actually performed to obtain a result value of the index thereafter, and the obtained result value is stored for future forecasting are repeated is common. A system in which matters that new data is received at each point in time and certain processing is performed for data at that point in time are repeated is usually called an online system, compared to a system in which all data are given at one time and processing is performed at one time.

For example, in a retail company having developed chain stores, commodities purchased in bulk from a maker are generally stored in a physical distribution warehouse, a list of slips in which commodities to be delivered to each store and the number of commodities are written is received every morning, and commodities are delivered to each store as needed. Also, the quantity of commodities delivered in one day is recorded as the result data and the quantity of commodities to be delivered on the day is forecasted based on past result data.

As the background art of the technical field of the present invention, there is PTL 1. In PTL 1, a forecasting model of the index value in which the newest processing result at that point in time is reflected is prepared each time when a new input is obtained. With this, PTL 1 has a configuration in which forecasting following change is performed even in a case where a relationship between the input and the index changes with time.

### CITATION LIST

### Patent Literature

PTL 1: JP-A-2004-117228

### SUMMARY OF INVENTION

### Technical Problem

In the online forecasting system, a tendency of a processing target changes slowly and also an accidentally caused great change in the tendency is not uncommon.

For example, in the physical distribution warehouse, a tendency of received slips at a special day such as in an opening period of a large-scaled event or during long holidays is largely different from a normal day. As such, in a case where there is a special day which is composed of peculiar data and has a relationship between an input x and y which is largely different from other days among the past N days, generally, it is considered that forecasting with high accuracy is possible by preparing a forecasting model using data of remaining days except for the special day. In the example of the physical distribution warehouse, it is considered that forecasting accuracy in forecasting a picking time of a normal day is improved by excluding data of such a special day.

As another example, the relationship between the input x and y may be largely different from a previous one bordering a certain specific day in the latter half of the past N days. In this case, it is considered that forecasting with high accuracy is possible by using only newest data except for data before the specific day, in preparing for a forecasting model of today. In the example of the physical distribution warehouse, matters that a temperature is abruptly raised after the rainy season passes and Christmas business began are considered factors.

In the online forecasting system described in PTL 1, all pieces of result data for the past N days are handled equally to construct the forecasting model of the index and forecasting of the index value of today from input data of today is performed based on the constructed forecasting model. Accordingly, there is a problem to be solved that it is difficult to follow abrupt change in the tendency.

An object of the present invention is to provide an online forecasting system capable of accurately performing forecasting of an index value even in a case where there is abrupt change in a tendency among past result data.

### Solution to Problem

In order to achieve the object described above, the present invention adopts a configuration in which input data of a predetermined day is received, result data of an index value of a day antedating the predetermined day is stored, similarity between the input data of the predetermined day and each of the stored result data is calculated, a weight for each of the result data based on the calculated similarity is calculated, and the index value of the predetermined day is forecasted based on the calculated weight, the result data, and the input data of the predetermined day.

### Advantageous Effects of Invention

According to the present invention, influence by data of a special day or influence before the specific day is made small to thereby make it possible to improve forecasting accuracy of the index value.

### BRIEF DESCRIPTION OF DRAWINGS

FIG. 1 is a block diagram illustrating an example of a configuration of an online forecasting system in Example 1 of the present invention.

FIG. 2 is an activity diagram illustrating an example of an operation of the online forecasting system in Example 1 of the present invention.

FIG. 3 is a block diagram illustrating an example of a configuration of an online forecasting system in Example 2 of the present invention.

FIG. 4 is an activity diagram illustrating an example of an operation of the online forecasting system in Example 2 of the present invention.

FIG. 5 is a diagram illustrating an example of stored contents of a result database of a past optimum weight in Example 2 of the present invention.

FIG. 6 is an activity diagram illustrating an example of a calculation method of an optimum weight vector in Example 2 of the present invention.

FIG. 7 is an example of a display screen in which a weight w(t−j, t) is arranged in a matrix pattern.

FIG. 8 is an example of a screen in which weights are displayed in a matrix pattern in a case where a relationship between an input x and an index y in only a certain specific day is different from that of other days.

FIG. 9 is an example of a screen in which weights are displayed in a matrix pattern in a case where the relationship between the input x and the index y is periodically changed at a period of three days.

FIG. 10 is an example of a screen in which weights are displayed in a matrix pattern in a case where tendencies of the relationships between the input x and the index y are different from each other before and after bordering a specific day.

### DESCRIPTION OF EMBODIMENTS

In the following, embodiments of the present invention will be described in detail using the drawings. In respective drawings, common configurations are assigned the same reference numerals as a matter of principle and repetitive explanations will be omitted. In the following Examples, an example of a physical distribution warehouse of a retail company having developed chain stores is used.

In the retail company having developed chain stores, commodities purchased in bulk from a maker are generally stored in a physical distribution warehouse and commodities are delivered to each store as needed. In the physical distribution warehouse, a list of slips in which commodities to be delivered to each store and the number of commodities are written is received every morning. When the list of slips is received, a physical distribution warehouse worker picks up the commodities according to commodity names and the number of shipments described in the slips while going around commodity storage shelves within the physical distribution warehouse, packs all commodities described in a single slip together, and ships the commodities to each store. A delivery deadline time is attached to each slip and shipment processing needs to be completed until that time. In the physical distribution warehouse, matters that man hours required for picking work for the slips of that day, that is, so to speak, total man hours are estimated and the number of the physical distribution warehouse workers needed to end the picking work within a required time is secured, or order of work is changed, based on the past experience, that is, recorded result data, at the point in time of receiving the list of slips to be subjected to shipment processing on that day in the morning are performed. Each time when actual picking work is ended, actual time required for picking processing is recorded and is used for future forecasting.

### Example 1

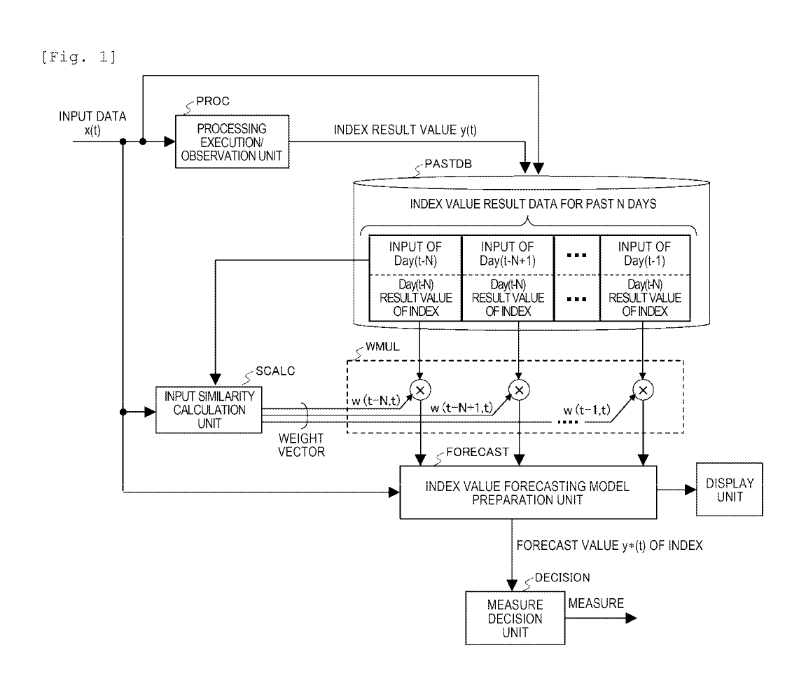

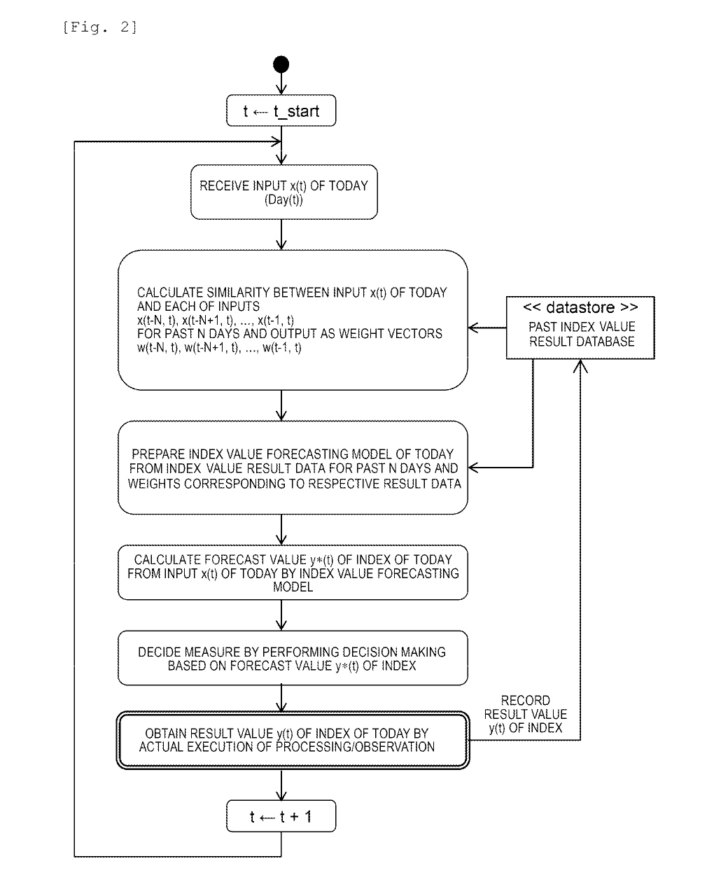

FIG. 1 is a block diagram illustrating a configuration of an online forecasting system in Example 1 and FIG. 2 is an activity diagram illustrating an operation of the online forecasting system. The online forecasting system of FIG. 1 is configured with a past index value's result data storing unit PASTDB, an index value forecasting model preparation unit FORECAST, a measure decision unit DECISION, a processing execution/observation unit PROC, a weight multiplication unit WMUL, and an input similarity calculation unit SCALC.

The past index value's result database PASTDB stores inputs by the past N days, that is, a list of slips x(t−N), x(t−N+1), . . . , x(t−1) and the index values by the past N days, that is, result values of a picking work time y(t−N), y(t−N+1), . . . , y(t−N), when N is a positive integer, as a set.

In the online forecasting system of Example 1, when the index value forecasting model preparation unit FORECAST prepares a forecasting model of the index value, the forecasting model of the index value is prepared by applying weights w(t−N, t), w(t−N+1, t), . . . , w(t−N, t) on data of respective days based on the result data x(t−N), x(t−N+1), . . . , x(t−1) for the past N days and y(t−N), y(t−N+1), . . . , y(t−N) stored in the past index value's result data storing unit PASTDB.

Here, the weight w(t1,t2) is a numerical value indicating how much a weight is applied to be taken into account for result data of the index value of Day(t−1) when the index value forecasting model of Day(t−2) is prepared. With this, when the forecasting model of the index value of today (Day(t)) is prepared, in a case where only Day(t−k) is composed of peculiar data and has the relationship between the input x(t−k) and the y(t−k) which is largely different from other days, for example, for a certain integer k of 1≤k≤N, among result data of the index values of the past N days, matters that the weight w(t−k, t) of past data of Day(t−k) is made smaller to prepare a forecasting model in which influence by peculiar data of Day(t−k) is made small become possible.

In a case where only data of Day(t−k) is different from other days, matters that the weight w(t−k, t) is made small is not necessarily optimum. For example, the input x(t) of today (Day(t)) is similar to only the input x(t−k) of the special Day(t−k) and is not similar to inputs of other days, inversely, the weight w(t−k, t) to be applied to past data of Day(t−k) is made large so as to make it possible to improve forecasting accuracy of the index value. Accordingly, it is considered that the weights w(t−N, t), w(t−N+1, t), . . . , w(t−N, t) for the result data of the past N days used when the forecasting model of today is prepared are preferably applied by being depended on how much the input x(t) of today is similar to the input x of each of the past days.

In the following, operations of the online forecasting system of Example 1 will be described in order. The online forecasting system receives an input of data x(t) to be processed today (Day(t)) every morning. In the example of the physical distribution warehouse, the list of slips (list of slips to be processed today) to be received every morning corresponds to data to be received. Next, the input similarity calculation unit SCALC compares the input x(t) of today with each of inputs x(t−N), x(t−N+1), . . . , x(t−1) for the past N days stored in the past index value's result data storing unit PASTDB to calculate similarity and outputs weight vector w(t−N, t), w(t−N+1, t), . . . , w(t−1, t) composed of N numerical values.

As a calculation of similarity, for example, a method of calculating feature quantity vectors from respective inputs x and regarding the reciprocal of a distance between the feature quantity vectors as similarity may be considered. A feature quantity used for this case may be set in advance, or can be obtained by a configuration for automatically extracting from examples of multiple inputs x by a known “unsupervised machine learning method” such as a self-organization mapping or a deep neural network.

The weight multiplication unit WMUL multiplies the result value y(t−j) of the index of Day(t−j) stored in the past index value's result data storing unit PASTDB by the weight w(t−j, t) calculated by the input similarity calculation unit SCALC and outputs the result to the index value forecasting model preparation unit FORECAST.

Next, the index value forecasting model preparation unit FORECAST prepares a forecasting model used for forecasting the index value of today, that is, an index value forecasting model from the result data of the past index value stored in the past index value's result data storing unit PASTDB. In this case, the result data of Day(t−j) is prepared by applying the weight w(t−j t) thereto. For this, a method of obtaining a regression model for, for example, the forecasting model used for forecasting the index value of today, by a weighted least square method by using the input x(t−j), the result value of the index y(t−j), and the weight w(t−j, t) may be used. Specifically, a regression coefficient vector β which minimizes a weighted least square error S expressed in the following Equation 1 may be obtained.

$$S = {\sum }_{j = 1}^{N} w ( t - j , t ) {\{ y ( t - j ) - β \cdot x ( t - j ) \}}^{2} \qquad [ Expression 1 ]$$

In Expression 1, the center point indicates an inner product between the vectors. The input x and the index value y may not be a single numerical value but a vector composed of a plurality of numerical values. In Expression 1, a case where the input x(t−j) is a vector is described. In this case, a dimension of the regression coefficient vector β is the same as that of the input x. Otherwise, as another method of preparing the forecasting model, a configuration in which learning is performed by applying a weight to supervisor data in a known “supervised machine learning method” called a neural network and Boltzman machine may be available.

As described above, a configuration in which the index value forecasting model preparation unit FORECAST operates as a learning device having an internal state and learns result data of a newly added index value online every day may be considered, instead that a forecasting model of the index of that day is newly prepared using the result data of the past index every day. As the online learning device, a known “supervised online machine learning method” called an online neural network or online Boltzman machine can be used.

Next, the index value forecasting model preparation unit FORECAST performs forecasting of the index value y(t) of today from the input x(t) of today based on the prepared forecasting model and calculates a forecast value y*(t). In the example of the physical distribution warehouse, this correspond to matters that total working hours of the picking work required for the processing from the list of slips to be processed today are estimated.

Next, the measure decision unit DECISION performs some kind of measure decision based on the calculated forecast value y*(t) of the index. In the example of the physical distribution warehouse, this correspond to matters that the number of workers needed to end work within the request time is calculated. The number of needed workers is calculated based on, for example, a standard work time per a single worker.

Thereafter, the processing execution/observation unit PROC actually executes processing for a target system or observes the target system to acquire a result value y(t) of the index of today. In the example of the physical distribution warehouse, this corresponds to matters that the total picking work time is measured in a case where the worker actually performs the picking work for each slip. When the result value y(t) of the index of today is acquired, the input x(t) of today and the result value y(t) of the index are stored in the past index value's result data storing unit PASTDB as a set. With this, the set of the input x(t) of today and the result value y(t) of the index is taken into account when the index value forecasting model at or after tomorrow (Day(t+1)) is prepared.

With this, the newest result value of the index is reflected in preparation for the index value forecasting model at all times and it becomes possible to timely follow change in the tendency of the result value of the index. In the present Example, only the result data of the past N days is taken into account in preparing for the index value forecasting model, and thus, data of a day before the N day may be appropriately deleted.

In the above-description, a configuration in which the result data of the past N days (N is an integer determined in advance) is taken into account and data before the N day is not taken into account in preparing for the index value forecasting model is adopted, a configuration in which the result data before the N day is taken into account, that is, all pieces of past data stored in the past index value's result data storing unit PASTDB are used in preparation for the index value forecasting model may be considered. In this case, a configuration in which the weight w(t−j, t) for past data which is older is made small may be adopted and, for example, a weight w is made smaller at a fixed rate as data becomes older. This is based on an idea that generally, data of a day closer to today tends to closer to data of today (being similar to data of today).

Otherwise, matters that control called “the older the data, the smaller the weight w” is not performed may be considered. This is because, typically, as the input x(t−j) in the past becomes older, a difference between the input x(t−j) and the input x(t) of today becomes large (similarity is lowered) and thus, the weight w(t−j, t) for past data which is older tends to become naturally smaller value even without controlling the weight w.

As described above, according to the online forecasting system in Example 1, a weight is applied to past result data by similarity between the input x(t) of today and the past input to thereby make it possible to prepare the forecasting model of the index value and improve forecasting accuracy of the forecast value y*(t) of the index value.

### Example 2

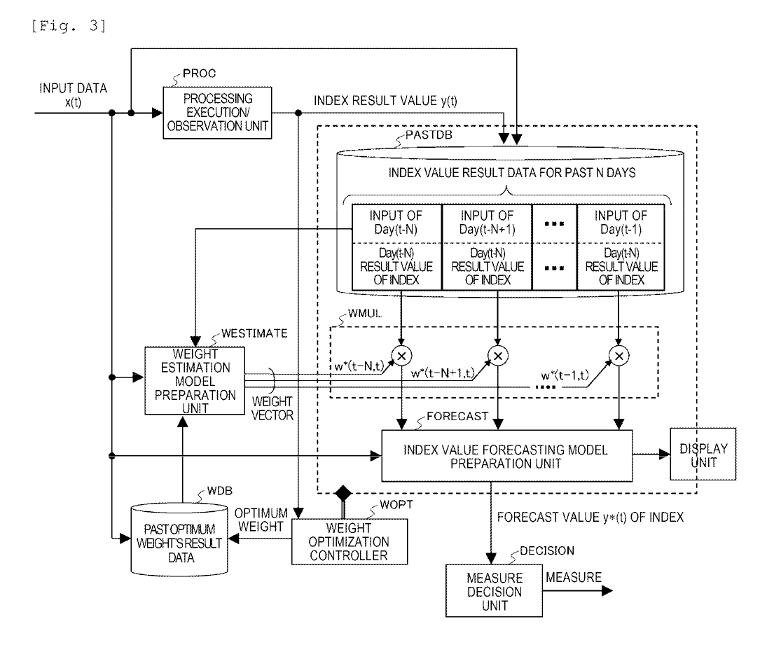

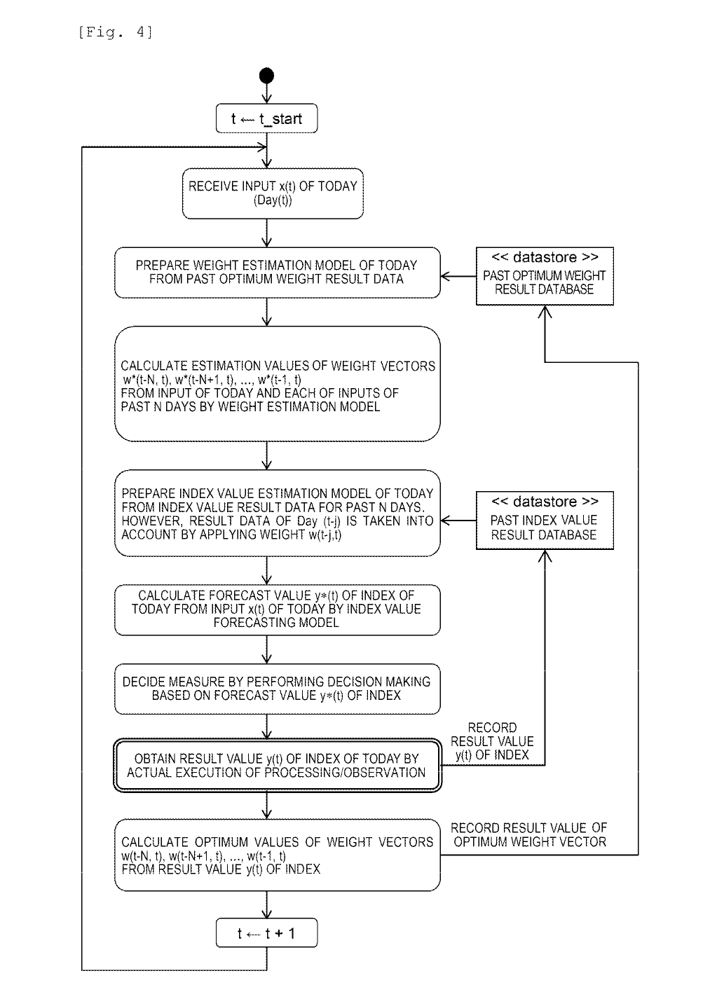

FIG. 3 is a block diagram illustrating a configuration of an online forecasting system in Example 2 and FIG. 4 is an activity diagram illustrating an operation of the online forecasting system. The online forecasting system of FIG. 3 is configured in such a way that the input similarity calculation unit SCALC is replaced with a weight estimation model preparation unit WESTIMATE and further, a past optimum weight's result data storing unit WDB and a weight optimization controller WOPT are newly added, in the online forecasting system illustrated in FIG. 1 (Example 1).

In Example 1, in the online forecasting system, the input x(t) of today is compared with respective input x(t−N), x(t−N+1), x(t−1) for the past N days stored in the past index value's result data storing unit PASTDB to calculate similarities and the calculated similarities are set as weight vectors w(t−N, t), w(t−N+1, t), . . . , w(t−1, t). This is based on an idea that a large weight is applied to result data of the index in an input similar to the input x(t) of today to prepare a forecasting model of the index value so as to make it possible to improve forecasting accuracy of the forecast value y*(t) of the index of today.

However, similarity between the input x(t) of today and an input x(t−j) of a past certain day Day(t−j) and a weight w(t−j, t) optimum for the Day(t−j), that is, the weight w(t−j, t) by which the forecast value y*(t) of the index of today forecasted by the prepared forecasting model becomes closest to a true value y(t) are not in a simple proportional relationship. Accordingly, like Example 1, when the forecasting model is prepared by using similarity, as it is, as a weight, there is a possibility that forecasting accuracy of the forecast value y*(t) of the index becomes low.

Here, Example 2 is characterized in that the weight estimation model preparation unit WESTIMATE prepares a weight estimation model using the result data of the past optimum weight stored in the past optimum weight's result data storing unit WDB and the weight estimation model preparation unit WESTIMATE estimates an estimation value w*(t−j, t) of the optimum weight w(t−j, t) from the input x(t) of today and the input x(t−j) of the past day Day(t−j).

The result value (true value) of the optimum weight w(t−j, t) can be obtained by calculating the weight vectors w(t−N, t), w(t−N+1, t), . . . , w(t−1, t) so that an error of the forecast value y*(t) of the index with respect to the result value y(t) is minimized, after the result value y(t) of the index of today is obtained by the processing execution/observation unit PROC.

In the following, the operations of the online forecasting system of Example 2 will be described in order using FIG. 4. The online forecasting system of Example 2 receives an input of data x(t) to be processed today (Day(t)) every morning. Next, the weight estimation model preparation unit WESTIMATE prepares a forecasting model, that is, a weight estimation model used in estimation of the weight vector of today, based on the past optimum weight's result data storing unit WDB.

FIG. 5 illustrates an example of a database stored in the past optimum weight's result data storing unit WDB. The database illustrated in FIG. 5 stores result data of the weight vectors for the past M days, when M is an integer of 1 or more. The result database illustrated in FIG. 5 stores the input x(t−j) of Day(t−1), the input x(t−1) of Day(t−1), and a weight w(t−j,t−1) of Day(t−j) to Day(t−1) as a set.

In a case where data as illustrated in FIG. 5 is stored in the past optimum weight's result data storing unit WDB, it is possible to prepare a weight estimation model by a method in which a linear multi-regression analysis is conducted by using, for example, the weight w(t−j,t−1) as an objective variable and the input x(t−j) of Day(t−j) and the input x(t−1) of Day(t−1) are descriptive variables to obtain a regression model, in preparing for the weight estimation model. Otherwise, as another method of preparing the weight estimation model, a configuration in which learning is performed by applying a weight to supervisor data in a known “supervised machine learning method” called a neural network and Boltzman machine may be available.

As described above, a configuration in which the weight estimation model preparation unit WESTIMATE operates as a learning device having an internal state and learns result data of a newly added optimum weight online every day may be considered, instead that the weight estimation model is newly prepared using past optimum weight result data in a certain point in time every day. As the online learning device, a known “supervised online machine learning method” called an online neural network or an online Boltzman machine can be used.

Next, the weight estimation model preparation unit WESTIMATE calculates the estimation values w*(t−N, t) w*(t−N+1, t), . . . , w*(t−1, t) of the weight vectors from the input x(t) of today and the inputs x(t−N), x(t−N+1), . . . , x(t−1) for the past N days based on the prepared weight estimation model. The estimated weights w*(t−N, t), w*(t−N+1, t), . . . , w*(t−1, t) are displayed in a matrix pattern so as to make it possible for a user to visually grasp change in a tendency of result data of the index value. Details of the way of displaying will be described later in Example 3.

The weight multiplication unit WMUL multiplies the result value y(t−j) of the index of Day(t−j) stored in the past index value's result data storing unit PASTDB by the weight w*(t−j, t) calculated by the weight estimation model preparation unit WESTIMATE and outputs the multiplication result to the weight index value forecasting model preparation unit FORECAST.

Next, the index value forecasting model preparation unit FORECAST prepares the forecasting model, that is, the index value forecasting model used in forecasting the index value of today based on result data in the past stored in the past index value's result data storing unit PASTDB and the estimation value of the weight vector prepared by the weight estimation model preparation unit WESTIMATE. In this case, the result data of Day(t−j) is prepared by applying the weight w*(t−j, t) thereto. A specific method of preparing the index value forecasting model is the same as Example 1.

Next, the index value forecasting model preparation unit FORECAST performs forecasting of the index value y(t) of today from the input x(t) of today using the prepared index value forecasting model to calculate the forecast value y*(t). This is the same as processing of Example 1.

Next, the measure decision unit DECISION performs some kind of measure decision based on the forecast value y*(t). This is the same as processing of Example 1.

Thereafter, the processing execution/observation unit PROC actually executes processing for a target system or observes the target system to acquire the result value y(t) of the index of today and records the input x(t) of today and the result value y(t) of the index of today, as a set, in the past index value's result database PASTDB. This is the same as processing of Example 1.

Next, the weight optimization controller WOPT calculates the optimum values of the weight vectors w(t−N, t), w(t−N+1, t), . . . , w(t−1, t) from the result value y(t) of the index of today. In the weight estimation model preparation unit WESTIMATE, the result value y(t) of the index of today is known after processing is performed by the processing execution/observation unit PROC and the result value y(t) of the index of today is obtained while the result value y(t) of the index of today is unknown at the point in time when the weight vector is prepared and thus, it is possible to calculate the optimum weight vectors w(t−N, t), w(t−N+1, t), . . . , w(t−1, t) causing the error of the estimation value y*(t) of the index to the result value y(t) to be minimized. This is executed in such a way that the weight optimization controller WOPT repeatedly activates the past index value's result database PASTDB, the weight multiplication unit and the index value forecasting model preparation unit FORECAST according to an optimization method.

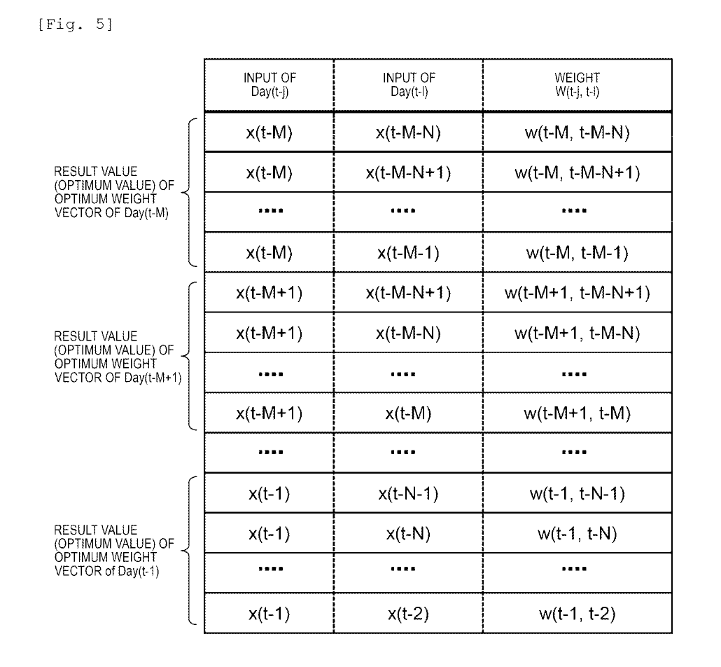

FIG. 6 is an activity diagram for explaining detailed operations of processing for calculating the optimum weight vector. Calculation of the weight vector is performed by a known optimization method, such as a steepest descent method or a simplex method. First, initial values w(t−N, t), w(t−N+1, t), . . . , w(t−1, t) of the weight vectors in optimization processing are determined. For this, a method in which respective elements w(t−j t) of the weight vectors are randomly selected from a possible weight range and set as initial values is considered. Here, although the possible weight range is typically 0 or more to 1 or less, the possible weight range may be a range other than the range from 0 or more to 1 or less depending on a configuration of the optimization algorithm to be used. Otherwise, a method in which the estimation values w*(t−N, t), w*(t−N+1, t), . . . , w*(t−1, t) prepared by the weight estimation model preparation unit WESTIMATE are used as the initial values of the weight vectors is considered.

Next, the forecasting model of the index value is prepared by using the current weight vectors w(t−N, t), w(t−N+1, t), . . . , w(t−1, t) and the forecast value y*(t) of the index is calculated by the forecasting model of the index value prepared.

Next, a difference r=y*(t)−y(t) between the forecast value y*(t) and the result value y*(t) obtained in the processing execution/observation unit PROC described above is calculated. When the difference r converges, the current weight vectors w(t−N, w(t−N+1, . . . , w(t−1, t) are set as the optimum weight vectors to be output and processing is ended. In a case where the difference r does not converge, according to the optimization method which is being used, the current weight vectors w(t−N, t), w(t−N+1, t), . . . , w(t−1, t) are updated so that the difference r is minimized, and preparing for the forecasting model of the index value and calculating of a forecast value of the index are repeated again.

The optimum weights w(t−N, t), w(t−N+1, t), . . . , w(t−1, t) determined here are displayed in a matrix pattern so as to make it possible for a user to visually grasp change in a tendency of the result data of the index value. Details of the way of displaying will be described later in Example 3.

When the optimum weight vectors w(t−N, t), w(t−N+1, t), . . . , w(t−1, t) are obtained, for j which is an integer of 1 or more to N or less, the input x(t−j) of Day(tj), the input x(t) of today, and a weight w(t−j, t) of Day(t−j) to today are stored in the past optimum weight's result data storing unit WEB, as a set. With this, a set of the x(t−j), the x(t), and the w(t−j, t) is taken into account at the time when the weight estimation model at or after tomorrow (Day(t+1)) is prepared.

By doing as described above, the result value having the newest optimum weight is reflected in the weight estimation model at all times and it becomes possible to timely follow change in the tendency of the result value of the index. Here, only the result data of the optimum weight of the past M days is taken into account in preparing for the weight estimation model and thus, data of days before the past M days may be appropriately deleted.

In processing described above, a configuration in which only the result data having the optimum weight of the past M days, for M which is an integer determined in advance, is taken into account and data of days before the past M days is not taken into account in preparing for the weight estimation model is adopted, a configuration in which the result data of days before the past M days is taken into account, that is, all pieces of past data stored in the past optimum weight's result data storing unit WDB are used in preparing for the weight estimation model may be considered.

The weight estimation model allows to catch a tendency which does not change very large of the processing execution/observation unit PROC compared to matters that the index value forecasting model allows to catch a tendency which changes in a relatively short period of time of the processing execution/observation unit PROC and thus, it is considered that an excellent result is frequently obtained by using all pieces of usable result data including older data in preparing for the weight estimation model.

As described above, according to the online forecasting system in Example 2, the weight between the input x(t) of today and the past input is estimated based on the result data having the optimum weight calculated from the result value of the index so as to make it possible to improve forecasting accuracy of the forecast value y*(t) of the index.

### Example 3

Example 3 is an example in which the weight w(t1,t2) applied to result data of the past index value is displayed in a matrix pattern so as to make it possible for a user to visually grasp change in a tendency of the weight (or change in a tendency of result data of the index value) in the online forecasting system of Example 1 and Example 2. In Example 1 and Example 2, the weight w(t−j, t) indicates how much a weight is applied to be taken into account for data of the result value of the index before j days, that is, for Day(t−j) when the index value forecasting model is prepared in Day(t).

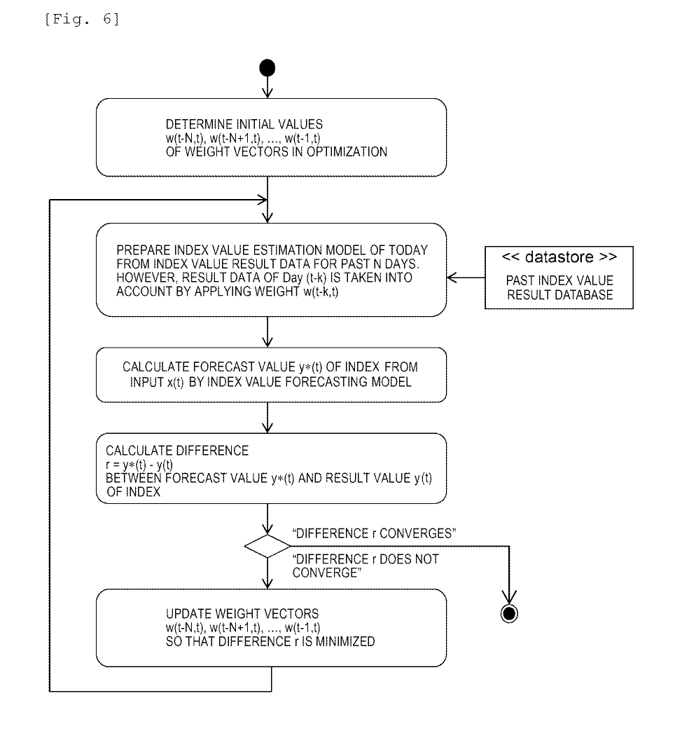

FIG. 7 illustrates an example of a display screen in which the weight w(t−j, t) is arranged in a matrix pattern. FIG. 7 is an example of a screen in which the weight w(t−j, t) is arranged in a matrix pattern to be displayed by making t larger as it goes rightward in the lateral direction and making j larger as it goes downward in the vertical direction.

The weight w(t−j, t) indicates what extent the input x(t−j) of Day(t−j) and the result data y(t−j) of the index value are to be taken into account in forecasting the index value y(t) of Day(t) from the input x(t) of Day(t). That is, it is possible to regard the weight w(t−j, t) as indicating what extent the relationship between the input x and the index value y shows similar tendency between Day(t−j) and Day(t).

Like FIG. 7, the weights are displayed in a matrix pattern so as to make it possible for a user to visually grasp a tendency that the relationship between the input x and the index y of a certain specific day is different from that of other days or the tendency changes bordering a certain day.

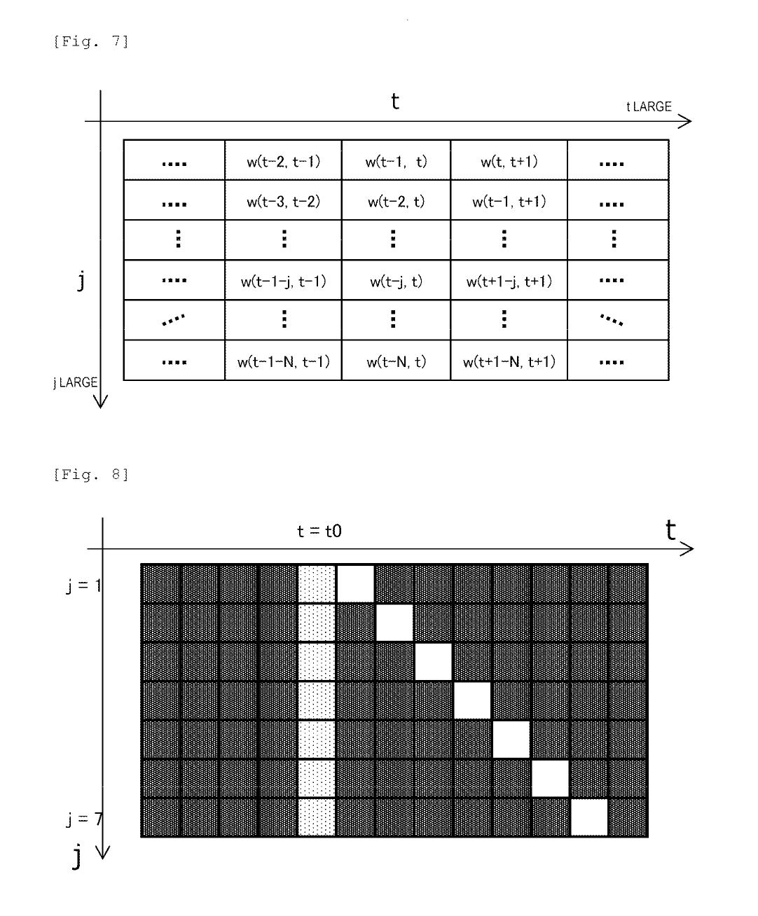

FIG. 8 is an example of a screen in which weights are displayed in a matrix pattern in a case where the tendency of the relationship between the input x and the index y of only a specific day (Day(t0)) is different from that of other days. N is set as N=7. In FIG. 8, shading of a cell represents magnitude of a value of the weight w(t−j, t) (for example, s dark cell: weight is large, pale cell: weight is medium, and white cell: weight is small). As such, magnitude of the numerical value of each weight is displayed by shading or a difference of color of the cell without displaying the numerical values themselves of the weight w(t−j, t) in a matrix pattern, so that the user becomes able to further visually grasp change in a tendency of the weight. Otherwise, when the numerical value of the weight w(t−j, t) is displayed on each cell and further, a background color of a cell is colorized in correlation with the weight w(t−j, t), the user becomes able to visually grasp change due to the difference of color of the cell and acquire information of the numerical value of the weight at the same time.

In FIG. 8, the numerical value of the weight becomes small in a vertical column at t=t0 and slanted columns toward a right lower portion from a cell (t0−1, t0) compared to that of other cells. Matters that the weight of the vertical column of at t=t0 is small indicate that the tendency of the result data of Day(t0) is different from that of other days and thus, all pieces of past result data, that is, the pieces of result data before Day(t0) are useless in preparing for the forecasting model at Day(t0). Matters that the weight is small in slanted columns toward a right lower portion from the cell (t0, t0+1) indicate that the result data of Day(t) is useless in preparing for the forecasting model at a day at or after Day(t0). The user searches for a pattern in which values of weights are small in the vertical and oblique directions from among the displayed weight matrix so as to make it possible to visually grasp the special day of which the tendency is different from that of other days.

In a case where only the tendency of result data of Day(t0) is different from that of other days, all pieces of past result data, that is, all pieces of result data before Day(t0) are equally useless in forecasting at Day(t0) and thus, a relative difference is hardly generated between weights of the vertical column at t=t0 and weights of cells before t=t0. Accordingly, especially, when the weight is set in Example 2, as illustrated in FIG. 8, the values of the weights do not become so small in the vertical column at t=t0 That is, a difference of the vertical column (pale cells) at t=t0 with the cells (dark cells) other than slanted columns (white cells) toward a right lower portion from a cell (t0, t0+1) may be visually vague compared to the slanted columns (white cells). Accordingly, in a case where the user searches for the pattern of the special day from a display screen in which weights are displayed in a matrix pattern, it is preferable to pay attention to the slanted columns first.

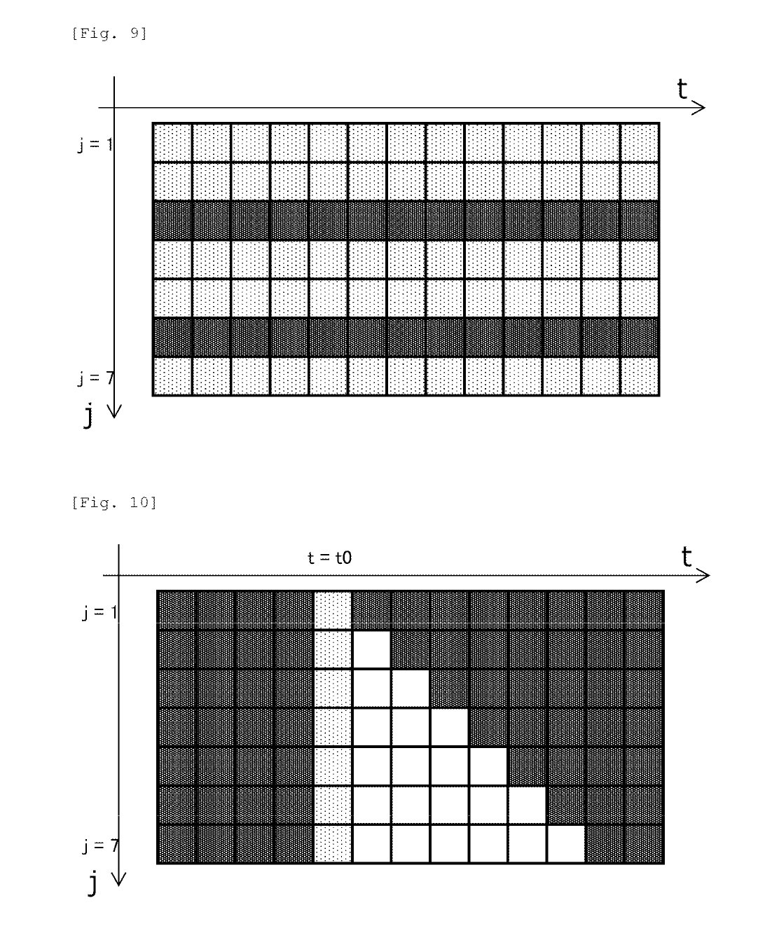

FIG. 9 is an example of a screen in which weights are displayed in a matrix pattern in a case where the tendency in the relationship between the input x and the index y is periodically changed at a period of three days. In this case, the weight becomes a large value in a lateral column every third column from j=3−1=2 in compliance with the period of three days. The user searches for a pattern of a lateral column in which the weight has the large value from among the matrix of weight displayed like FIG. 9 so as to make it possible to visually grasp a periodic pattern included in change in the tendency of the weight.

FIG. 10 is an example of a screen in which weights are displayed in a matrix pattern in a case where tendencies of the relationships between the input x and the index y are different from each other before Day(t0) (not including Day(t0)) and at or after Day(t0) (including Day(t0)) bordering the specific day Day(t0). In this case, the weight becomes a value smaller than those of other cells in a wedge shaped area having the cell (t0-1, to) as an apex. By the same reason as the case of FIG. 8, the value of the weight may not become so small in the vertical column at t=t0. The user searches for a pattern of a lateral column of which the weight is the small value in the wedge shaped area from the weights displayed in a matrix pattern so as to make it possible to visually grasp matters that the tendency changes bordering a certain day.

In the example of a screen described here in which the weights are displayed in a matrix pattern, j is set to a range from 1 or more to N or less in compliance with matters that N weights w(t−N, t), w(t−N+1, t), . . . , w(t−1, t) to be respectively applied to past data for the past N days every day are set. However, as described in Example 1 and Example 2, a method in which the number of days of past data to be taken into account in preparing for the forecasting model of the index value is not determined in advance is also available. In this case, the number of vertical rows may be different for each column in displaying the matrix pattern of the weights of FIG. 7.

Until now, although 1 is set as an integer of 1 or more in the weight w(t−j, t), matters that a negative integer can be set as j in the matrix pattern display of the weights can be considered. In a case where j is the negative integer, when it is set that j′=−j, w(t−j, t)=w(t+j′, t) represents a weight in a case where the result data of the index of Day(t+j′), which is after Day(t), can be used in preparing for the forecasting model of the index of Day(t). In the online forecasting system, although it is impossible to use result data of a future index in forecasting the index of today and the w(t+j′, t) is rarely considered, as explained in Example 3, it is useful to take into account the w(t−j′, t) for the purpose of matters that the user visually grasps chancre in a tendency of a consideration target system. Actually, in a case where the weight w(t−j, t) relating to the negative integer j is displayed, a portion where j is positive may be displayed in a lower side of the axis t and a portion where j is negative may be displayed in an upper side of the axis t in FIG. 7.

As described above, according to the online forecasting system in Example 3, the weight w(t−j, t) used in preparing for the forecasting model of the index is presented to the user in a matrix shape so that the user is able to visually grasp change in the tendency of the relationship between the input x and the index y.

The embodiments described above are just one instance for realizing the present invention and a technical scope of the present invention is not limited thereto.

Some or all of respective configurations, functions, processing units, and processing means described above may be realized by hardware by designing those in, for example, an integrated circuit. The respective configurations, functions, and the like may be realized by software in such a way that a processor interprets a program realizing the respective functions and executes the program. Information such as the program realizing the respective functions, a table, and a file can be placed in a recording device such as a memory, a hard disk, or a solid state drive (SSD) or a recording medium such as an IC card, an SD card, or a DVD.

The present embodiment is not limited to an example of the physical distribution warehouse and can be generally applied to the online processing system.

As another example, a retail store is considered. In the retail store, the number of store visitors or sales of that day is forecasted from day of the week, weather, information about events held in the vicinity, or the like based on past result data and the number of purchases, a job shift of a clerk, or the like is determined according to the forecasted number of store visitors or sales of that day. At the closing time, the result value of the number of actual store visitors or the actual sales of that day is recorded as result data and is used at or after the present time. In the example of the retail store, it may be considered that day of the week, weather, information about events held in the vicinity, or the like corresponds to input data in the online processing system described above, the number of store visitors or sales corresponds to the index in the online processing system described above, and determining of the number of purchases, a job shift of a clerk, or the like from the forecasted value of the number of store visitors or sales corresponds to measure decision in the online processing system described above.

As still another example, financial investment is considered. In the financial investment, profits to be obtained in the future through investment are forecasted from various financial index values or information related to an investment target in each point in time based on past result data and it is determined whether investments should be actually performed or not. Thereafter, a result value of the actually obtained profits is recorded as result data and is used for forecasting at or after the present time. In the example of financial investment, various financial index values or information related to an investment target in each point in time correspond to input data in the online processing system described above, the profits to be obtained in the future through investment correspond to the index in the online processing system described above, and the determination as to whether investments should be actually performed or not from a forecasted value of future profits corresponds to measure decision in the online processing system described above.

### REFERENCE SIGNS LIST

PROC: processing execution/observation unit
PASTDB: past index value's result data storing unit
FORECAST: index value forecasting model preparation unit
DECISION: decision making unit
SCALC: input similarity calculation unit
WMUL: weight multiplication unit
WESTIMATE: weight estimation model preparation unit
WDB: past optimum weight's result data storing unit
WOPT: weight optimization controller

1. An online forecasting method for forecasting an index value of a predetermined day based on input data of the predetermined day, the online forecasting method comprising:
storing result data of an index value of a day before the predetermined day;
receiving input data of the predetermined day;
calculating similarity between the input data and each of the stored result data;
calculating weight for each result data based on the calculated similarity; and
forecasting the index value of the predetermined day based on the calculated weight, the result data, and the input data of the predetermined day.

2. The online forecasting method according to claim 1, further comprising:
performing display of the weight for each result data by being differentiated according to a value of the weight.

3. The online forecasting method according to claim 1, further comprising:
acquiring result data of the index value of the predetermined day; and
using the acquired result data of the index value of the predetermined day and the input data of the predetermined day in forecasting an index value of a day after the predetermined day.

4. An online forecasting system that forecasts an index value of a predetermined day based on input data of the predetermined day, the online forecasting system comprising:
an index value result data storing unit that stores result data of an index value of a day before the predetermined day;
a similarity calculation unit that calculates similarity between the input data of the predetermined day and each of the stored result data to calculate a weight corresponding to the stored result data; and
a forecasting unit that forecasts the index value of the predetermined day based on the calculated weight, the stored result data, and the input data of the predetermined day.

5. The online forecasting system according to claim 4, further comprising:
a display unit that displays the weight for each result data by being differentiated according to a value of the weight.

6. The online forecasting system according to claim 4,
wherein the index value result data storing unit stores the result data of the index value of the predetermined day, and
the forecasting unit uses result data of the index value of the predetermined day and the input data of the predetermined day in forecasting an index value of a day after the predetermined day.

7. An online forecasting system that forecasts an index value of a predetermined day based on input data of the predetermined day, the online forecasting system comprising:
an index value result data storing unit that stores result data of an index value of a day before the predetermined day;
an optimum weight result data storing unit that stores an optimum value of a weight corresponding to each result data of the stored index value;
a weight estimation unit that calculates an estimation value of the weight for each result data of the index value stored in the index value result data storing unit based on the stored optimum value of the weight, the result data of the stored index value corresponding to the optimum value of the weight, and the input data of the predetermined day; and
a forecasting unit that forecasts the index value of the predetermined day based on the calculated estimation value of the weight, the input data of the predetermined day, and the result data of the index value stored in the index value result data storing unit.

8. The online forecasting system according to claim 7, further comprising:
an observation unit that observes the result data of the index value of the predetermined day; and
a weight optimum value calculation unit that calculates an optimum value of a weight corresponding to the result data of the index value of the predetermined day based on the observed result data of the index value of the predetermined day and the index value of the predetermined day forecasted by the forecasting unit.

9. The online forecasting system according to claim 8,
wherein the optimum weight result data storing unit stores the optimum value of the weight calculated by the weight optimum value calculation unit as an optimum value of a weight corresponding to the result data of the index value of the predetermined day.
